(19) United States
(12) Patent Application Publication
(10) Pub. No.: US 2007/0297869 A1
(43) Pub. Date: Dec. 27, 2007

(54) Through insert with floating capability

(76) Inventor: James J. Kunda, Snohomish, WA (US)

Correspondence Address: WILDMAN HARROLD ALLEN & DIXON LLP;AND THE BOEING COMPANY, 225 W. WACKER DR., CHICAGO, IL, 60606, US

(21) Appl. No.: 11/475,296

(22) Filed: Jun. 26, 2006

(51) Int. Cl. F16B 37/04

(52) U.S. Cl. 411/108

(57) ABSTRACT

A floating insert comprises a stud, a nut, and a cap. The stud comprises a flat base portion and a cylindrical stud portion mounted onto the flat base portion. The cylindrical stud portion comprises a stud cylinder aperture. The nut is inside the stud cylinder aperture. The cap comprises a flat cap portion and a cylindrical cap portion mounted onto the flat cap portion. The cylindrical cap portion receives the cylindrical stud portion.

### BACKGROUND

When securing an object, such as a piece of furniture or equipment, to a panel, such as a honeycomb composite panel, it is often desirable to first install an insert into the panel, and then drive a fastener such as a bolt or screw through a hole in the object and into the insert. One disadvantage of using such an insert to attach an object to the panel is their inability to provide ballistic protection. The inserts can be categorized as either through or blind.

A through insert extends through the panel and has portions contacting both sides of the panel, creating a high level of structural strength. However, the through inserts do not have the capability to float; therefore, if a through insert is installed in a location on the panel that is not precisely aligned with the hole in the object through which the fastener will be driven, the object may not be secured to the through insert. This necessitates either moving the object, or removing and re-installing the through insert.

A blind insert is installed from one side of a panel after a hole has been created, and is secured within the hole with an adhesive such as potting compound. Some blind inserts include an internal floating nut element that allows an object to be attached to the blind insert even if the object is not precisely aligned with the hole. However, the blind insert does not extend all the way through the panel, and does not provide as much structural strength as the through inserts.

### SUMMARY

The above-mentioned drawbacks associated with existing inserts are addressed by embodiments of the present application, which will be understood by reading and studying the following specification.

In one embodiment, a through insert with floating capability comprises a stud, a cap, and a nut. The stud has a flat base portion and a cylindrical stud portion mounted on the flat base portion. The cylindrical stud portion comprises a stud cylinder aperture. The cap comprises a flat cap portion and a cylindrical cap portion mounted on the flat cap portion. The nut is located inside the stud cylinder aperture, such that the nut can move within the stud cylinder aperture. The cylindrical cap portion receives the cylindrical stud portion.

In another embodiment, a method for securing an object to a panel comprises creating a hole in a panel, inserting a stud into the hole in the panel, placing a nut into a stud cylinder aperture, placing a cap onto the stud, and driving a fastener through a hole in an object, through a flat cap aperture, and through the nut. In this embodiment, the stud comprises a flat base portion and a cylindrical stud portion mounted on the flat base portion, and the cylindrical stud portion comprises the stud cylinder aperture. The cap comprises a flat cap portion and a cylindrical cap portion mounted on the flat cap portion, and the flat cap portion comprises the flat cap aperture.

In another embodiment, a through insert assembly comprises a two-part outer shell that threads together to attach a through insert assembly to a panel, and a floating threaded inner component that is captured by the outer shell.

In another embodiment, a vehicle comprises a panel and an object mounted to the panel with one or more fasteners in cooperation with a corresponding number of through inserts with floating capability. The through inserts comprise a stud, a nut, and a cap. The stud has a flat base portion and a cylindrical stud portion mounted thereon, and the cylindrical stud portion comprises a stud cylinder aperture. The nut is located inside the stud cylinder aperture, such that the nut can move within the stud cylinder aperture. The cap has a flat cap portion and a cylindrical cap portion mounted thereon, and the cylindrical cap portion receives the cylindrical stud portion.

These and other embodiments of the present application will be discussed more fully in the detailed description. The features, functions, and advantages can be achieved independently in various embodiments of the present application, or may be combined in yet other embodiments.

### BRIEF DESCRIPTION OF DRAWINGS

FIG. 1 shows a perspective view of an insert with a cap connected to a stud.

FIG. 2 shows a perspective view of the insert with the cap disconnected from the stud.

FIG. 3 shows a perspective view of the cap with a cylindrical cap aperture facing the viewer.

FIG. 4 shows an exploded view of the insert, with the stud installed onto a panel, and a locking nut and the cap separated from the stud.

FIG. 5A shows a perspective view of the insert installed onto the panel from a side which shows a flat base portion of the stud.

FIG. 5B shows a perspective view of the insert installed onto the panel from a side which shows an object secured to the insert by a fastener.

FIG. 6 shows a cross-sectional view of the insert.

FIG. 7 shows a perspective view of a vehicle utilizing the insert.

Like reference numbers and designations in the various drawings indicate like elements.

### DETAILED DESCRIPTION

In the following detailed description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that various changes may be made without departing from the spirit and scope of the present invention. The following detailed description is, therefore, not to be taken in a limiting sense.

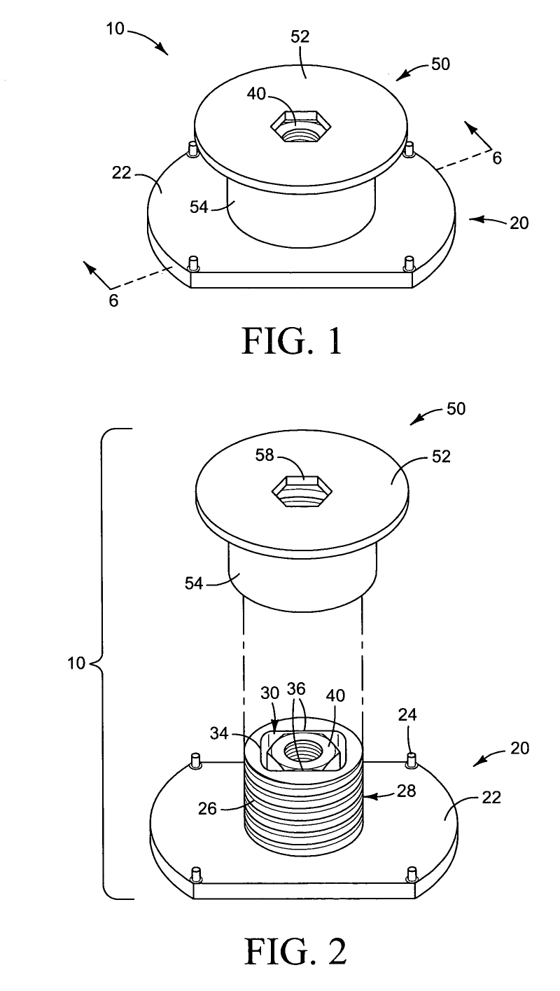

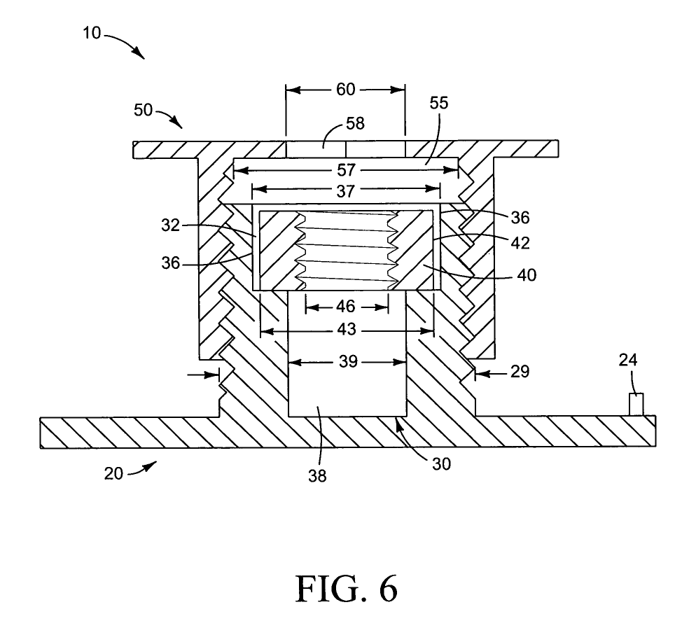

FIG. 1 shows a perspective view of an insert [10] in an assembled position, with the dashed line 6 showing the line along which the cross-sectional view shown in FIG. 6 is taken. The insert [10] comprises a stud [20], a nut [40], and a cap [50]. The stud [20] and cap [50] may be comprised of a non-ballistic material, such as aluminum, mild steel, or other non-metallic material or, alternatively, be comprised of a ballistic material, such as steel (e.g., stainless steel) or titanium. The stud [20] comprises a flat base portion [22], on which may be mounted a plurality, such as four, anti-rotation projections [24]. An adhesive material such as potting compound may be used in conjunction with or as a substitute for the anti-rotation projections [24]. In some embodiments, an outer perimeter of the flat base portion [22] has a polygonal (e.g., hexagonal) shape.

The cap [50] comprises a flat cap portion [52], and a cylindrical cap portion [54]. The cylindrical cap portion [54] is mounted at or near a center of the flat cap portion [52].

FIG. 2 shows a perspective view of the insert [10], with the cap [50] disconnected from the stud [20]. As shown in FIG. 2, the stud [20] further comprises a cylindrical stud portion [26]. The cylindrical stud portion [26] comprises a threaded outer surface [28], and a stud cylinder aperture [30]. The threaded outer surface [28] does not need to extend along the entire length of the cylindrical stud portion [26].

The stud cylinder aperture [30] comprises an upper aperture perimeter [34] which comprises at least two aperture perimeter surfaces [36]. The two aperture perimeter surfaces [36] are parallel to each other, and a length of each of the aperture perimeter surfaces [36] is greater than a distance between them.

The flat cap portion [52] of the cap [50] comprises a cap aperture [58] at or near a center of the flat cap portion [52]. In the illustrated embodiment, the cap aperture [58] is hexagonal to facilitate tightening the cap [50] onto the stud [20] by an Allen wrench. It is envisioned that in other embodiments, the cap aperture [58] is designed to cooperate with other tightening devices. The cap aperture [58] overlays a threaded cylindrical cap aperture [55] of the cylindrical cap portion [54], as described below.

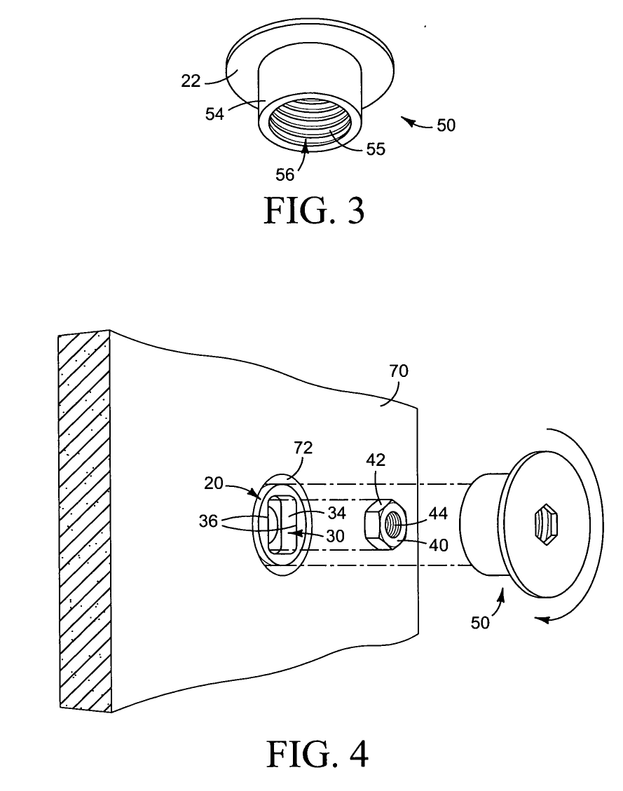

FIG. 3 shows a perspective view of the cap [50] alone. As shown in FIG. 3, the cylindrical cap portion [54] comprises a cylindrical cap aperture [55] and a threaded interior surface [56]. The cylindrical cap aperture [55] is the volume contained by the cylindrical cap portion [54]. The cylindrical cap aperture [55] and threaded interior surface [56] are configured so that the cylindrical cap portion [54] may receive the cylindrical stud portion [26] when the cap [50] is screwed onto the stud [20].

FIG. 4 shows an exploded view of the insert [10] and a panel [70] such as a wall or partition, with the stud [20], nut [40], and cap [50] separated from each other. The panel [70] may be made of a composite honeycomb structure, such as that used as a partition for an aircraft cockpit. The stud [20] has been inserted into a hole [72] created in the panel [70]. The length of the cylindrical stud portion [26] may be chosen based on the thickness of the panel [70]. The hole [72] should have the same or slightly greater diameter than the cylindrical cap portion [54].

As shown in FIG. 4, the nut [40] comprises a nut outer perimeter [42] and a nut threaded aperture [44]. In some embodiments, the nut [40] comprises a locking nut. The nut outer perimeter [42] traces an exterior surface of the nut [40]. In the illustrated embodiment, the nut outer perimeter [42] is hexagonal. In other embodiments, the nut outer perimeter [42] may comprise a wide variety of shapes having at least two opposite parallel sides.

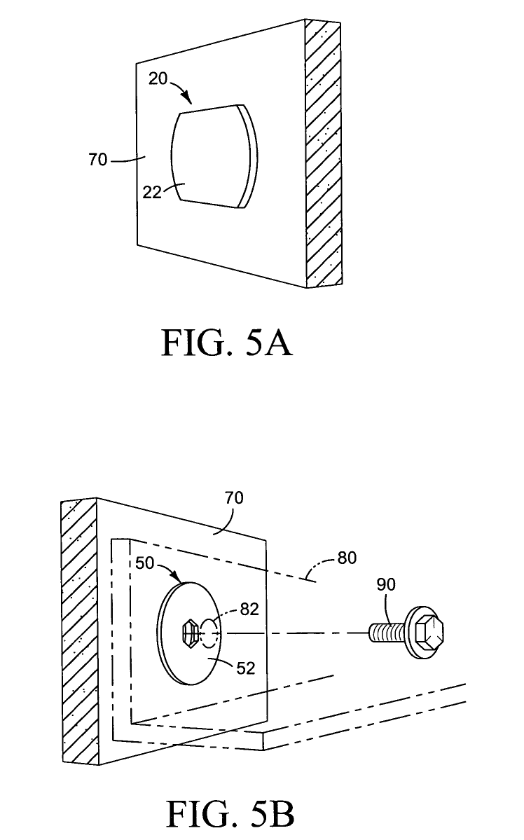

The nut threaded aperture [44] is a recessed, cylindrical aperture comprising an interior surface of the nut [40] configured to receive and hold a fastener [90] (shown in FIG. 5B). The fastener [90] may be a threaded, cylindrical device such as a bolt or screw, that is configured to be screwed into the nut [40]. The size of the nut [40] may vary to accommodate different sized fasteners [90]. If a larger fastener [90] is used, then the whole insert [10] is increased in overall size to account for the increase in fastener [90] size.

FIG. 5A shows a perspective view of the insert [10] installed onto the panel [70] from a side onto which the stud [20] is installed. As shown in FIG. 5A, the flat base portion [22] of the stud [20] is flush with the panel [70]. The anti-rotation projections [24] or adhesive material may grip the panel [70] and prevent the stud [20] from rotating.

FIG. 5B shows a perspective view of the insert [10] installed onto the panel [70] from a side showing an object [80], such as a piece of furniture or equipment, secured to the panel [70]. As shown in FIG. 5B, the flat cap portion [52] of the cap [50] is flush with the panel [70]. The fastener [90] is driven through a hole 82 created in the object [80], through the cap aperture [58], through the cylindrical cap aperture [55], and through the nut [40] so that the fastener [90] interlocks with the nut threaded aperture [44] of the nut [40].

FIG. 6 shows a cross-sectional view of the insert [10] cut along the dashed line 6 shown in FIG. 1, which shows many of the dimensions of the components of the insert [10]. The cap aperture [58] of the cap [50] comprises a cap aperture diameter [60], measured as a distance between opposite sides of the cap aperture [58]. The cylindrical cap aperture [55] comprises a cylindrical cap aperture diameter [57]. The cylindrical cap aperture diameter [57] is measured as an inner diameter of the threaded interior surface [56], that is to say, as a distance between the edges of the threads on opposite sides of the cylindrical cap aperture [55].

A nut exterior diameter [43] of the nut [40] is measured as a distance from one side of the nut outer perimeter [42] to an opposite side of the nut outer perimeter [42]. A nut threaded aperture diameter [46] is measured as an inner diameter across the nut threaded aperture [44], that is to say, as a distance between the edges of the threads on opposite sides of the nut threaded aperture [44].

The stud cylinder aperture [30] comprises an upper aperture portion [32] and a lower aperture portion [38]. An upper aperture diameter [37] is measured as a distance across the upper aperture portion [32] from one aperture perimeter surface [36] to the other. A lower aperture diameter [39] is measured as a diameter of the lower aperture portion [38]. A threaded outer surface diameter [29] of the cylindrical stud portion [26] is measured as an outer diameter of the threaded outer surface [28], that is to say, a distance between the outside edges of the threads on opposite sides of the threaded outer surface [28].

The upper aperture diameter [37] of the stud cylinder aperture [30] is the same as or slightly greater than a nut exterior diameter [43], allowing the nut [40] to fit into the upper aperture portion [32]. The upper aperture diameter [37] is greater than the lower aperture diameter [39]. The lower aperture diameter [39] is less than the nut exterior diameter [43], allowing the nut [40] to rest above the lower aperture portion [38]. A length of the aperture perimeter surfaces [36] is greater than the nut exterior diameter [43]. The threaded outer surface diameter [29] is the same as or slightly greater than the threaded cylindrical cap aperture diameter [57]. The cap aperture diameter [60] is greater than the nut threaded aperture diameter [46].

The nut [40] may be placed into the upper aperture portion [32], resting above the lower aperture portion [38], because the upper aperture diameter [37] is greater than the lower aperture diameter [39], and the lower aperture diameter [39] is less than the nut exterior diameter [43]. The nut [40] is prevented from rotating because the distance between the parallel aperture surfaces [36] is the same as or slightly greater than the nut exterior diameter [43]. The nut [40] may slide back and forth in a dimension parallel to the aperture perimeter surfaces [36] because the length of the aperture perimeter surfaces [36] is greater than the nut exterior diameter [43].

The cap [50] may be screwed onto the stud [20] because the threaded outer surface diameter [29] is the same as or slightly greater than the threaded cylindrical cap aperture diameter [57], thereby allowing the threads and grooves of the threaded outer surface [28] and threaded interior surface [56] to interlock with each other. The fastener [90] may enter the insert [10] through the cap aperture [58] at an angle not perpendicular to the flat cap portion [52] because the cap aperture diameter [60] is greater than the nut threaded aperture diameter [46].

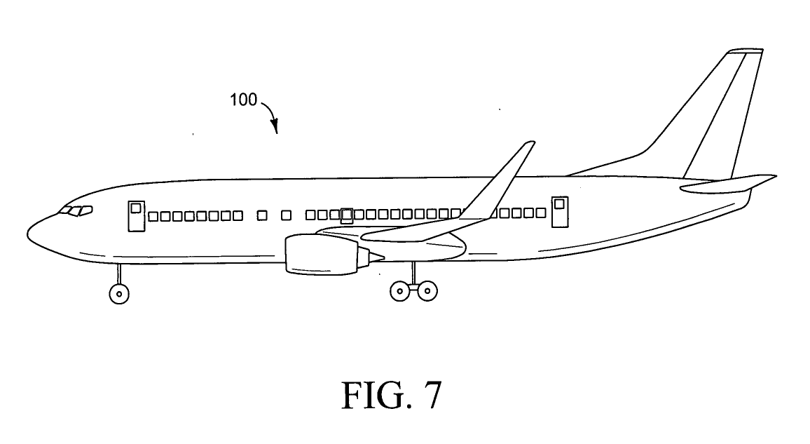

The insert [10] may be used to install an object [80] such as a piece of furniture or equipment onto a panel [70] in a situation where the fastener [90] needs to be connected to both the panel [70] and the object [80]. One application is securing objects [80] onto the panel [70] of a vehicle [100], such as the aircraft shown in FIG. 7.

In operation, a hole [72] is created in the panel [70], and the cylindrical stud portion [26] of the stud [20] is placed into the hole [72] in the panel [70]. The flat base portion [22] of the stud [20] is made flush with the panel [70], and the anti-rotation projections [24] or adhesive material, grip the panel [70] to prevent the stud [20] from rotating or sliding.

The nut [40] is placed into the upper aperture portion [32], and rests on the portion of the cylindrical stud portion [26] that surrounds the lower aperture portion [38]. The hexagonal shape of the nut [40] and the two aperture perimeter surfaces [36] allow the nut [40] to slide back and forth in a dimension parallel to the aperture perimeter surfaces [36], and to rock back and forth in the same dimension, but not to rotate, slide, or rock in a perpendicular dimension.

The cap [50] is then screwed onto the stud [20] by interlocking the threaded interior surface [56] with the threaded outer surface [28] until the flat cap portion [52] is flush with the panel [70]. The cap [50] is thereby locked onto the stud [20]. The fastener [90] may be driven through a hole 82 in the object [80], then through the cap aperture [58], and screwed into the nut [40]. If the fastener [90] was driven through the hole 82 in the object [80] at a location that was not precisely aligned with the nut threaded aperture [44], then the nut [40] may be moved or rocked along the dimension parallel to the aperture perimeter surfaces [36] to align the nut threaded aperture [44] with the fastener [90]. This movement of the nut [40] provides the insert [10] with floating capability to receive screws or bolts that are not precisely aligned with the insert [10]. If necessary, the stud [20] may be rotated so that the dimension parallel to the aperture perimeter surfaces [36] allows the nut threaded aperture [44] to be aligned with the fastener [90]. The fastener [90] is then driven through the nut [40], using an Allen wrench in some embodiments, thereby securing the object [80] to the panel [70].

In embodiments in which the nut [40] comprises a locking nut, the fastener [90] may be secured to the insert [10] such that the fastener [90] and the object are locked in place. Therefore, using a locking nut for the nut [40] reduces the likelihood that vibrations will cause the fastener [90] to twist and fall out of the nut [40].

Locking the stud [20] and the cap [50] together by interconnecting the threaded outer surface [28] with the threaded interior surface [56] improves retention of the insert [10] inside the panel [70]. The ability to lock the stud [20] and the cap [50] together can also obviate the need for potting compound or glue to secure an insert into the panel [70]. The flat base portion [22] of the stud [20] improves pullout strength by pressing against the panel [70].

In some embodiments, the insert [10] has the feature of ballistic resistance, enabling it to withstand the impact of a bullet. The floating feature of the nut [40] allows for tolerance of mismatches between the insert [10] and the object [80]. This tolerance advantageously decreases the installation time of objects [80] onto panels [70] by obviating the need to reconfigure a hole [72] in a panel [70] that was created in an incorrect location.

Although this invention has been described in terms of certain preferred embodiments, other embodiments that are apparent to those of ordinary skill in the art, including embodiments that do not provide all of the features and advantages set forth herein, are also within the scope of this invention. Rather, the scope of the present invention is defined only by reference to the appended claims and equivalents thereof.

What is claimed is:

1. A through insert with floating capability comprising:
a stud having a flat base portion and a cylindrical stud portion mounted thereon, the cylindrical stud portion comprising a stud cylinder aperture;
a nut located inside the stud cylinder aperture, such that the nut can move within the stud cylinder aperture; and
a cap having a flat cap portion and a cylindrical cap portion mounted thereon,
wherein the cylindrical cap portion receives the cylindrical stud portion.

2. The through insert of claim 1, wherein the stud comprises aluminum, mild steel, stainless steel, or titanium.

3. The through insert of claim 1, further comprising a plurality of anti-rotation projections or an adhesive material mounted on the flat base portion of the stud.

4. The through insert of claim 1, wherein an outer perimeter of the flat base portion of the stud has a polygonal shape.

5. The through insert of claim 1, wherein:
the flat cap portion comprises a flat cap aperture; and
a fastener extends through the flat cap aperture and through the nut.

6. The through insert of claim 2, wherein the flat cap aperture is hexagonal.

7. The through insert of claim 1, wherein:
the cylindrical stud portion comprises a threaded outer surface;
the cylindrical cap portion comprises a threaded inner surface; and
the cylindrical cap portion receives the cylindrical stud portion by interlocking the threaded inner surface onto the threaded outer surface.

8. The through insert of claim 1, wherein:
the cylindrical stud portion comprises a stud cylinder aperture;
the stud cylinder aperture comprises an upper aperture perimeter with at least two aperture perimeter surfaces; and
at least two sides of an exterior surface of the nut are in contact with the at least two aperture perimeter surfaces.

9. The through insert of claim 8, wherein a length of the at least two aperture perimeter surfaces is greater than a distance between the at least two aperture perimeter surfaces.

10. The through insert of claim 1, wherein:
the stud cylinder aperture comprises an upper aperture portion and a lower aperture portion; and
an upper aperture diameter is greater than a lower aperture diameter.

11. The through insert of claim 10, wherein the nut rests above the lower aperture portion.

12. A method for securing an object to a panel comprising:
creating a hole in the panel;
inserting a stud into the hole in the panel, the stud comprising a flat base portion and a cylindrical stud portion mounted thereon, the cylindrical stud portion having a stud cylinder aperture;
placing a nut into the stud cylinder aperture;
placing a cap onto the stud, the cap comprising a flat cap portion and a cylindrical cap portion mounted thereon, the flat cap portion having a flat cap aperture; and
driving a fastener through a hole in the object, through the flat cap aperture, and through the nut.

13. The method of claim 12, wherein placing the cap onto the stud comprises rotating a threaded interior surface of the cylindrical cap portion onto a threaded exterior surface of the cylindrical stud portion.

14. The method of claim 12, further comprising sliding the nut within the stud cylinder aperture in a dimension parallel to at least two aperture perimeter surfaces of the stud cylinder aperture.

15. A through insert assembly comprising:
a two-part outer shell that threads together to attach the through insert assembly to a panel; and
a floating threaded inner component that is captured by the outer shell.

16. The through insert assembly of claim 15, wherein the through insert assembly is ballistic resistant.

17. The through insert assembly of claim 15, wherein the floating threaded inner component comprises a locking nut.

18. A vehicle comprising:
a panel; and
an object mounted to the panel with one or more fasteners in cooperation with a corresponding number of through inserts with floating capability,
wherein the through inserts comprise:
a stud having a flat base portion and a cylindrical stud portion mounted thereon, the cylindrical stud portion comprising a stud cylinder aperture;
a nut located inside the stud cylinder aperture, such that the nut can move within the stud cylinder aperture; and
a cap having a flat cap portion and a cylindrical cap portion mounted thereon,
wherein the cylindrical cap portion receives the cylindrical stud portion.

19. The vehicle of claim 18, wherein the vehicle comprises an aircraft.

20. The vehicle of claim 18, wherein the panel comprises a composite panel.
